(19) United States
(12) Patent Application Publication
(10) Pub. No.: US 2014/0327501 A1
(43) Pub. Date: Nov. 6, 2014

(54) Sabbath Adapted Electrical Devices

(71) Applicant: Aharon Cohen, Bne Brak (IL)

(72) Inventor: Aharon Cohen, Bne Brak (IL)

(21) Appl. No.: 14/363,089

(22) PCT Filed: Dec. 3, 2012
(86) PCT No.: PCT/IL2012/000386

§ 371 Date: Jun. 5, 2014

Related U.S. Application Data
(60) Provisional application No. 61/566,706, filed on Dec. 5, 2011.
(60) Provisional application No. 61/678,032, filed on Jul. 31, 2012.

(51) Int. Cl. H01H 7/00; H01H 51/00

(52) U.S. Cl. CPC H01H 7/00; H01H 51/00
USPC 335/39

(57) ABSTRACT

A Sabbath adapted electrical device configured to enable normal usage on Sabbath without manually changing the electrical status of the electrical circuitry; open circuits remain open and closed circuits remain closed.

### BACKGROUND

The present invention relates generally to the operation of electrical devices during the Jewish Sabbath, and specifically, relates to their operation in a manner in which the electrical state of the electrical circuits remains unchanged on Sabbath even in the absence of customary pre-Sabbath preparations; closed circuits remain closed and open circuits remain open.

Proper observance of the Jewish Sabbath and many of the Holidays requires maintaining the electrical status of electric circuits existing at the onset of the day because opening a closed circuit or closing an open one constitutes a desecration of the day.

Therefore, as a matter of preparation, devices having Sabbath switches operative to disable electrical switches actuated by the closing and opening of a device door, for example, are set in a Sabbath mode to render door switches unresponsive to opening and closing the door prior to the onset of the day to prevent the noted desecration.

Sabbath observant users that forget to disable the electric door switches prior to Sabbath are in a dilemma on Sabbath because opening the refrigerator or freezer door will necessarily active a light and possible deactivate the fan and compressor, thereby desecrating the sanctity of the day.

Therefore, there is a need for provisions enabling full use of these devices in accordance with Jewish law when the necessary pre-Sabbath preparations in which the electrical switches have not been disabled prior to the Sabbath.

### BRIEF DESCRIPTION OF THE DRAWINGS

The primary features, components and their configuration, method of operation and advantages of the present invention may be understood with reference to the following detailed description and accompanying drawings in which:

FIGS. 1A-1B are front schematic views of an open and closed refrigerator, respectively, depicting a refrigerator light and a door switch;

FIG. 1C is a schematic side view of the open refrigerator of FIG. 1A;

FIGS. 2A and 2B are schematic perspective views of a rotatably-mounted, lock configuration linked to a door-switch in enabled and disabled states, respectively, according to an embodiment;

FIG. 2C is a schematic perspective view of lock configuration implemented as a secondary switch configured to disconnected the doors switch from an electrical supply when the door switch is in a closed state, according to embodiments;

FIGS. 3A and 3B are schematic perspective views of a magnetically-actuated lock configuration in which the door switch is disposed in enabled and disabled states, respectively, according to an embodiment;

FIG. 4A is a schematic view of a lock configuration implemented as cavity and a slidable shudder disposed in a refrigerator door, according to an embodiment;

FIG. 4B is a schematic side view of the door of FIG. 4A in which the shutter is disposed in non-switch actuating position; according to an embodiment;

FIGS. 5A and 5B are schematic front views of a lock configuration implemented as variant embodiment of the rotatably actuated lock configuration of FIGS. 3 and 3A in non-locking and locking states, respectively, according to embodiments;

FIGS. 6A and 6B are schematic front views of a lock configuration implemented as a slidable door-switch engagement-element in switch-actuating and switch actuating positions, respectively, according to embodiments;

FIGS. 7A and 7B are side, schematic views of a lock configuration implemented integrally with door-switch disabled in a closed circuit state, according to an embodiment,

FIGS. 7C and 7D are side, schematic views of a lock configuration implemented integrally with door-switch disabled in an open circuit state, according to an embodiment,

FIG. 8 is a block diagram of a timer-actuated lock configuration responsive to a passage of predefined time period in which a refrigerator door is open, according to an embodiment;

FIG. 8A is a flowchart of the timer-actuated lock configuration of FIG. 8, according to embodiments;

FIG. 8B is a block diagram of a calendar-actuated lock, according to an embodiment;

FIG. 8C is a flowchart depicting the steps of the calendar-actuated lock of FIG. 8B, according to an embodiment;

FIG. 9 is a block diagram of an electrical switch disabler, in which a switch biased to periodically change its electrical state is actuated by disabling a governor countering the switch biasing, according to an embodiment;

FIG. 9A is a flowchart depicting the steps of an electrical switch disabler of FIG. 9, according to an embodiment; and

FIG. 10 is schematic front view of a refrigerator having a lighting system employing light emitting diodes (LED) configured to remain activated throughout Sabbath; according to a embodiment.

### DETAILED DESCRIPTION

It should be appreciated that for the sake of clarity well-known methods, procedures, and components have been omitted from the non-limiting description of the Sabbath adapted electrical devices.

Embodiments of the present invention are Sabbath adapted devices configurable for Sabbath operation in a manner compliant with Jewish law even when customary pre-Sabbath disablement or deactivation has not been performed.

It should be appreciated that the present invention has application in many different types of devices like, inter alias, refrigerators, freezers, hot plates, heating urns, elevators, and other electrical device involving the closing and opening of electrical switches. As a matter of convenience and without reducing the scope, embodiments of the present invention will be discussed in the context of a refrigerator.

As noted, customary pre-Sabbath preparations include deactivating refrigerator door-switches to ensure that they are non-responsive to opening and closing the refrigerator door. Sabbath compliant operation of such devices may be accomplished by any one or a combination of any one of the following methods, according to embodiments:
Deactivate or disable the door switch prior to opening on Sabbath.
Render the door into non-switch actuating state . . .
Disconnect the door switch from a current flow.
Actuating a switch biased to periodically change its electrical state by disabling a governor countering the switch biasing.

The following definitions will be used through the document:

“Door-switch”, “push switch”, or “switch” refer to a non-latching switch which causes a temporary change in the state of an electrical circuit only while the switch is physically actuated. A biasing element, like a spring for example, returns the switch to its default position immediately afterwards, restoring the initial circuit condition. Upon activation, the switch changes either from a state enabling current flow to a state preventing it, or vice a versa.
“Push to make” switches, allow electricity to flow between its two contacts when held until the button is released.
“Push to break” switches, on the other hand, allow current flow on its biased state when the button is not pressed and breaks the circuit when it is pressed.
“Actuate” refers to an act causing the electrical state of the switch to change from its biased state.
It should be appreciated that latching push switches are also included in the scope of the present invention.
“Lock configuration” refers to a configuration causing the state of an electrical switch to remain in the same status even when an actuating force is applied or removed from the switch.
A “deactivated” or “disabled” switch refers to one that is locked into a either a conducting or a non-conducting state even an actuating force is applied or removed.
“Open switch” refers to a state in which current does not flow through the switch. and opening a switch refers to causing the switch to prevent current flow through it.
“Closed switch” refers to a switch through which current flows, similarly, closing a switch refers to placing a switch in a state in which current flows through the switch.
“Sabbath” refers to any day in which the opening and the closing of electrical circuits are prohibited, like Sabbath itself and other Jewish holidays having the same prohibition.

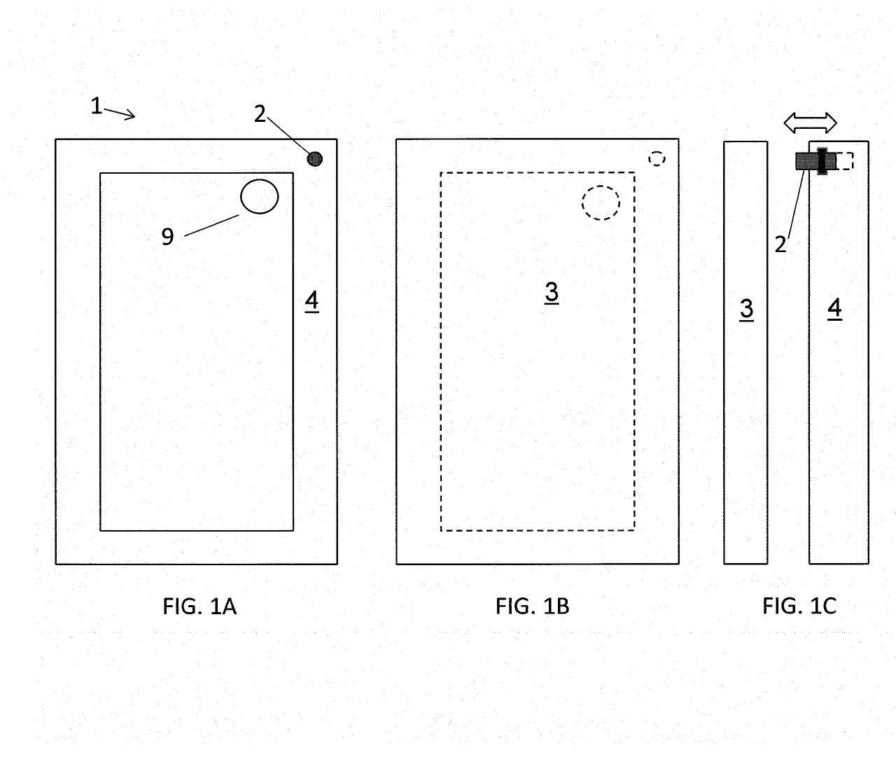

Turning now to the figures, FIGS. 1A and 1B depict a refrigerator, generally designated 1, including a frame 4, a door-switch 2, a light 9, and a door 3. FIG. 1C is a cutaway, side-view of frame 4 and door 3 revealing switch 2 in an open state in response to the removal of an actuating force from door 3 as it assumes an open position.

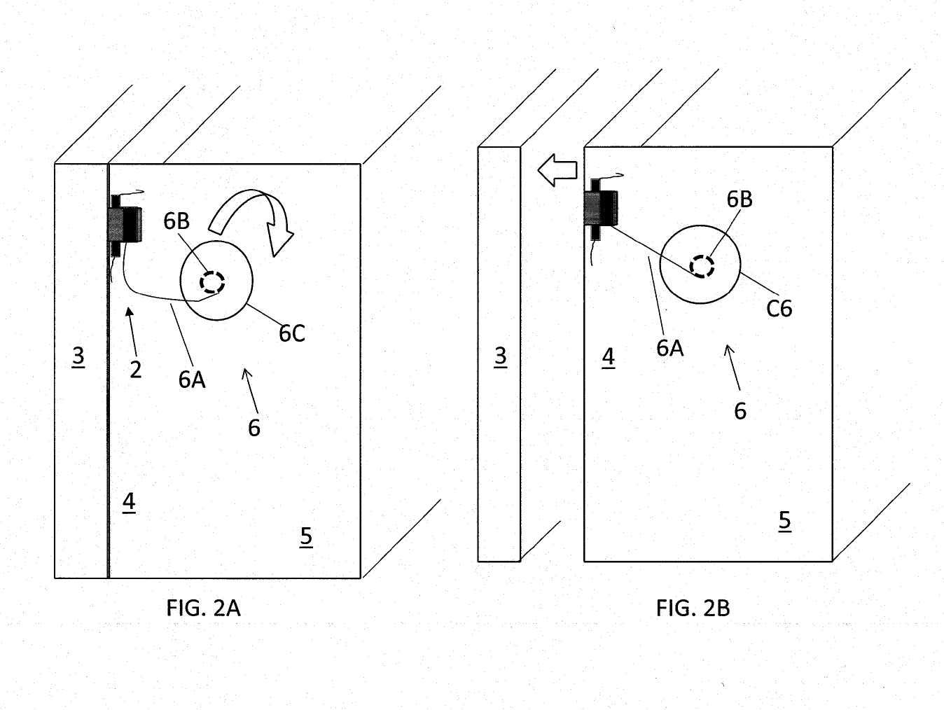

FIGS. 2A and 2B depict an example of a lock configuration operative to deactivating or disabling switch 2 on Sabbath prior to opening of door 3. Lock configuration or, in this implementation, control knob generally designated 6, includes a shaft 6B rotatably mounted to the outside of a refrigerator cabinet 5, a shaft handle 6C for receiving a torque, and a cord 6A or a flexible wire connected to shaft 6B and switch 2.

In operation, a torque is applied to handle 6C and cord 6A is wound around shaft 6B drawing taunt cord 6 and locking switch 2 in a closed-door state, thereby enabling a user to open door 3 without activating switch 2. It should be appreciated that in non-limiting embodiments, shaft 6B is rotatable upon applying a torque so that cord 6A remains taut until a counter torque is applied in the opposite direction to release cord 6A and unlock switch 2 after Sabbath.

It should be appreciated that a lever arrangement may be employed in place of cord 6A and may also be actuated the application of force as is known to those skilled in the art.

The lock configuration, generally designated 6, may be permanently or temporarily mounted to the refrigerator cabinet 5 or other appropriate locations providing such functionality. When attached temporarily, it may be attached with an adhesive or other temporary fastening means enabling a user to remove the lock mechanisms when not needed.

FIG. 2C is a schematic perspective view of lock configuration implemented as a secondary switch 4C configured to disconnected the doors switch 2 from an electrical supply 4B or feed current when the door switch 2 is in a closed-door state.

In operation, when the door is closed on Sabbath a user may actuate the secondary switch 4C to disconnect the door switch its circuit 4A to advantageously enable the door to be

opened throughout the day without causing a change in flow of current through door switch 2.

After the termination of the Sabbath, a user may return the door switch 2 to its customary functionality by re-connecting it to its circuit 4A by returning the secondary switch 4B to its pre-Sabbath setting.

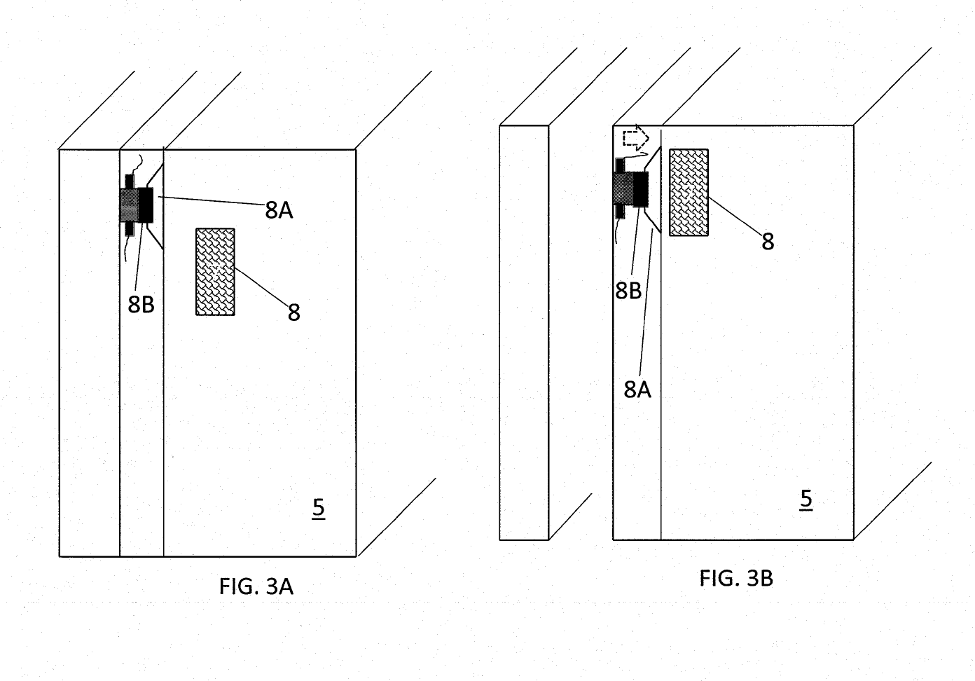

FIGS. 3A and 3B depict a magnetically actuated lock configuration in which switch 2 is held in a closed-door state magnetically when magnet 8 is disposed opposite switch 2 on the outside of cabinet 5, according to an embodiment of the present invention. This functionality is accomplished by way of a magnet-responsive element 8A linked to an electrical linkage 8B such that when element 8A is disposed within the magnetic field of magnet 8, element 8A together with the attached electrical linkage 8B are pulled towards magnet 8 with sufficient force to overcome a biasing mechanism biasing the switch 2 to close when door 3 is opened, according to a certain embodiment. It should be noted that element 8A may be implemented as a permanent or an electromagnet responsive to an iron based material disposed outside the cabinet, according to embodiments.

It should be noted that the torque and the magnetically actuated embodiments may, in other embodiments, be configured to lock switch 2 into an open-door state when the door 3 is opened on Sabbath. Furthermore, they may be linked to a retrofit door switch configured to replace standard door switches commonly supplied with refrigerators and freezers, for example.

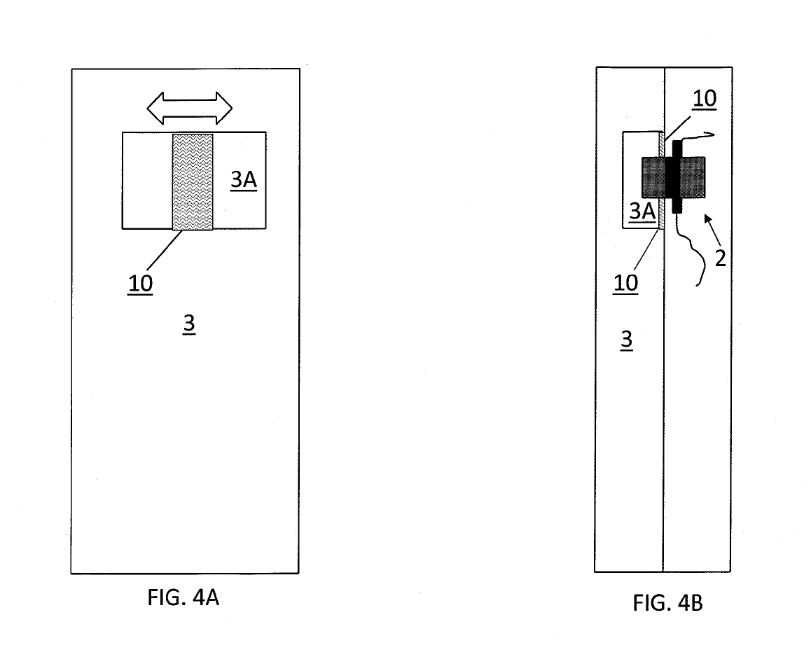

FIGS. 4A and 4B depict a non-limiting embodiment lock configuration directed at preventing a switch-contact-element associated with door 3 from bearing on switch 2 when door 3 assumes a closed position, thereby enabling a user to close and reopen and door 3 throughout Sabbath even when switch 2 has not been deactivated prior to Sabbath.

Specifically, door 3 contains a cavity 3A which may be selectably covered and uncovered by switch-contact-element implemented as a sliding shutter 10. It should be appreciated that vertically mobile shutters, accordion or collapsible shutters, or various arrangements revealing cavity 3A so that door 3 does bear on switch 2 upon closure are included within the scope of the present invention.

In operation, a door 3 that has been inadvertently opened on Sabbath, maybe be closed after sliding shutter 10 sideways so that switch 2 protrudes into cavity 3A when door 2 is closed as shown in FIG. 4B.

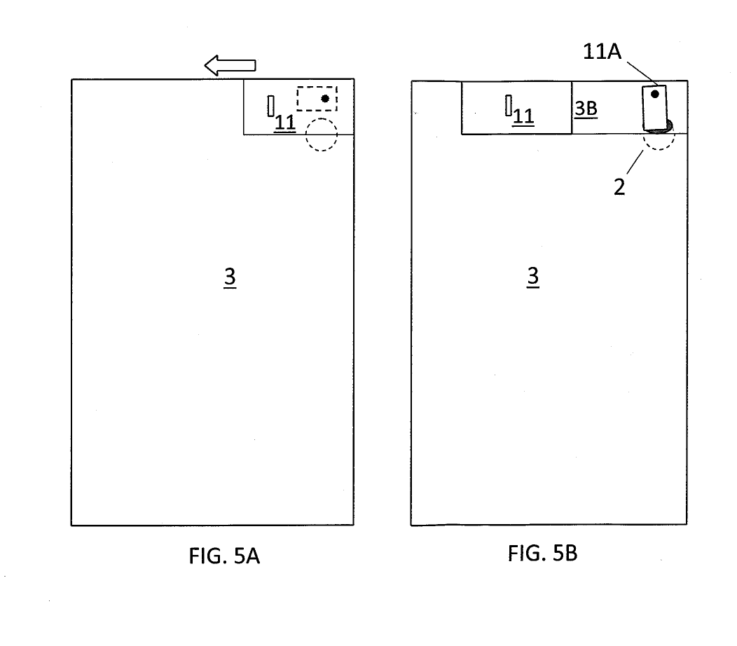

FIGS. 5A and 5B depict an additional, non-limiting embodiment of a lock configuration directed at locking switch 2 into a closed-door state while door 3 is still closed, even during Sabbath.

Specifically, door 3 has a window 3B covered by a slidable window cover 11 situated opposite switch lock 11A so as to enable a user to lock switch 2 into a closed-door state while switch 2 is still held in a closed-door state by door 3 bearing on a portion of the surface area of switch 2, according to certain embodiments.

As shown in FIG. 5B, when window cover 11 is slid sideways providing access to switch lock 11A, and switch lock 11A is rotated into a position blocking switch 2 so that when door 3 is opened switch 2 remains locked in a closed-door state.

It should be appreciated that embodiments in which the lock element 11A is configured to slide or otherwise move into a switch locking position and window cover 11 is hinged or configured to be vertically mobile are all included within the scope of the present invention.

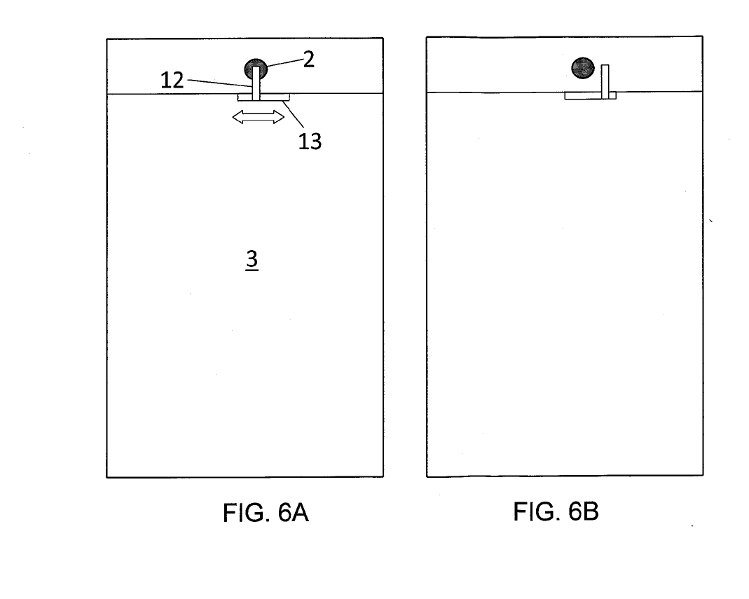

FIGS. 6A and 6B depict an additional non-limiting embodiment of a lock configuration preventing switch activation by moving switch-contact-element implemented

as slidable protuberance protruding from door 3 into a non-switch-actuation position after door 3 has been inadvertently opened on Sabbath.

Specifically, door 3 includes a switch-contact-element implemented as a slidable protuberance 12 mounted on a track 13 so as to enable protuberance 12 to slide horizontally.

In operation, after door 3 has been inadvertently opened on Sabbath, protuberance 12 may be slid sideways so that it does not bear on switch 2 when door 3 is re-closed on Sabbath, thereby leaving switch 2 in an open-door mode. It should be appreciated that embodiments in which the direction of motion is vertical of otherwise non-horizontal are included within the scope of the present invention.

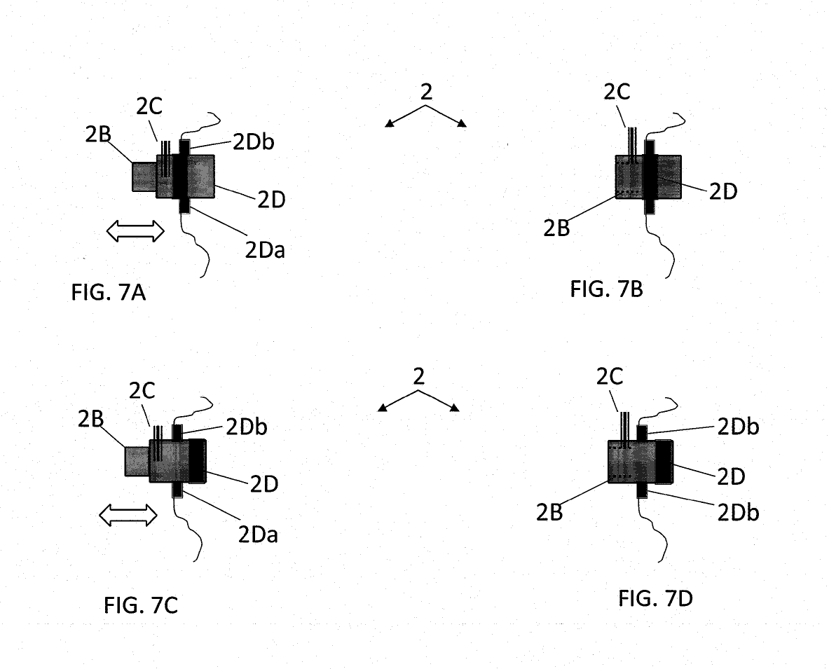

FIGS. 7A-7D depict deactivateable door-switches having a lock mechanism disposed integrally to push switch 2 such that the electrical state existing at the time the switch is disabled remains even when a force is applied or removed from the push switch, according to non-limiting embodiments.

Switch 2 is disabled by way of lock configuration implemented as button 2C configured to disengage push-button 2B from an electrical linkage 2D, according to non-limiting embodiments. Specifically, FIGS. 7A-7B depict a non-limiting example of switch 2 deactivated in a closed-circuit state in which electrical contact is maintained between contacts 2Da and 2Db by way of electrical linkage 2D.

Button 2C is further configured to re-engage electrical linkage 2D with the push-button 2B to resume normal switch functionality, in certain non-limiting embodiments.

FIGS. 7C-7D depict the deactivateable switch of FIGS. 7A and 7B disabled in an open-circuit state in which electrical linkage 2D is disposed in a state of non-contact with contacts 2Da and 2Db, according to non-limiting embodiments.

It should be appreciated that push switches implemented telescopically or with a collapsible sleeve are included within the scope of the present invention. Furthermore, push switches together with its integral lock configuration in certain embodiments are

implemented as retrofit switches configured to replace door switches in existing refrigerators, for example.

For example a push switch of an existing refrigerator may be disengaged from a refrigerator frame, and its circuitry connected to the retrofit unit after disconnection from the old door switch and then snap the retrofit into the appropriate window disposed in the refrigerator frame.

It should also be noted that various integral lock configuration may implemented with various types of mechanical interfaces like, inter alias, knobs or dials, levers, or even cords accessible to user outside the refrigerator when the door is closed. Furthermore, integral lock configurations may be implemented with various settings like, normal switch functionality, closed switch or open switch functionalities, in certain non-limiting embodiments.

Furthermore, it should be appreciated that embodiments combining various combinations of the disclosed embodiments are also within the scope of the present invention.

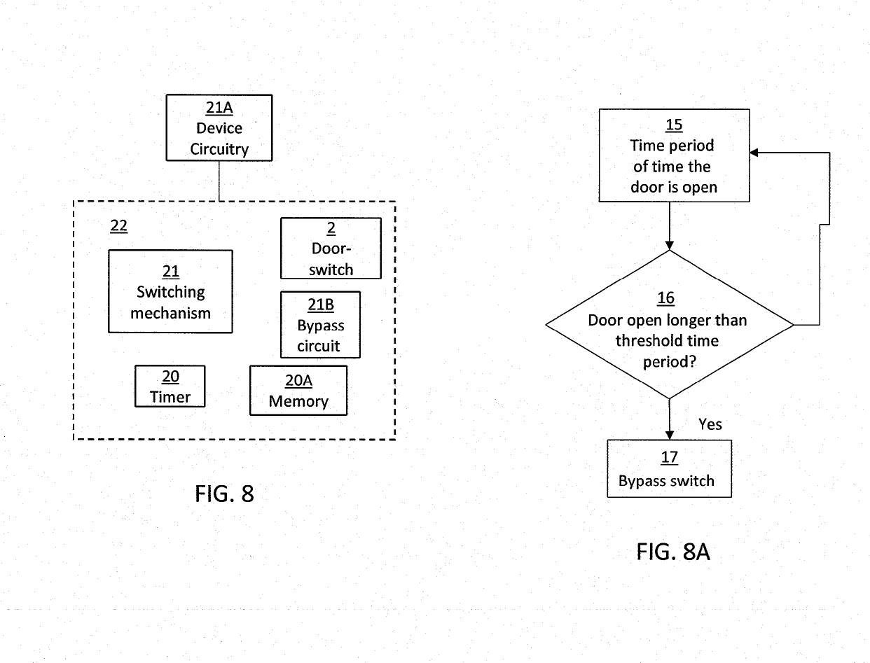

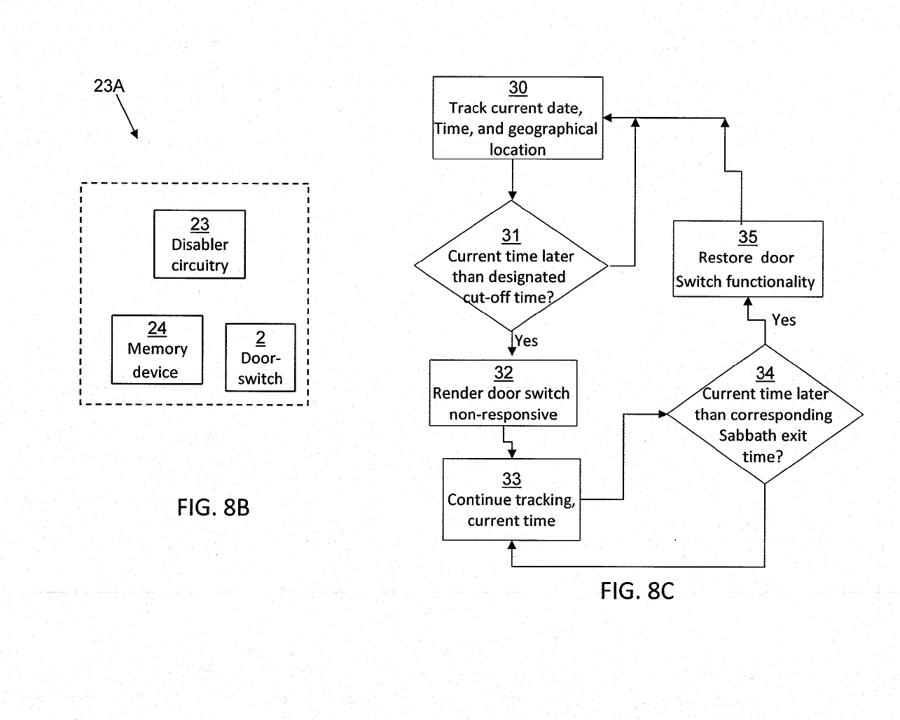

FIG. 8 is a block diagram of a time-actuated, lock configuration operative to disable door switch 2 responsively to passage of a predefined period of time in which door 3 has been inadvertently opened on Sabbath, according to embodiments.

The reset mechanism 22 includes a timer 20 actuated by door switch 2 and also linked to switching mechanism 21, a memory for storing a threshold time, a door switch 2, according to a non-limiting embodiment. In certain embodiments, the switching mechanism is configured to restore device circuitry to a closed-door state.

FIG. 8A is a flowchart depicting the operational steps of the reset mechanism 22 beginning with step 15 in which timer 20 measures the period of time the doors is open beginning from the moment the time switch 2 assumes an open-door state on Sabbath.

In step 16, the timed period is compared with a pre-defined threshold time period representing a maximum time period for which the door is generally opened during normal usage on non-Sabbath days; this value is stored in memory 20A, according to a certain embodiment.

If the currently measured time period is less than or equal to the threshold time period, the system 22 resets to a reiterative timing mode in step 15. If, however, the currently measured time period exceeds the threshold time period, processing continues to step 17 where switching mechanism 21 engages a bypass circuit 21B so as to restore the refrigerator to a closed-door state and to render switch 2 non-responsive to force applied during door closure. This functionality is based on typical user conduct after inadvertently opening the door and realizing the mistake of keeping the door open. The greatest time period in which the door is held open during the week defines the threshold value for establishing the door has been opened on Sabbath in certain embodiments and may include usage tracking provisions monitoring and storing the maximum time period in which the door is typically open or, in other embodiments, the threshold time may be set manually.

Embodiments in which switch mechanism 21 merely restores the circuitry to a closed-door state, prior to closure, switch 2 may be manually disabled by way of any of the above described methods or embodiments.

As noted above, the system may resume normal functionality when covering the cavity or by unlocking the door switch upon departure of Sabbath. It should also be appreciated that embodiments employing mechanical mechanisms configured to change an electrical orientation upon activation for a time period equal to a threshold time period also included within the scope of the present invention.

FIG. 8B depicts a lock configuration actuated in accordance with calendar time and date, according to an embodiment.

As shown, this embodiment includes a disabler circuit 23 in communication with memory device 24, door-switch 2 and switch bypass circuit 21A, in accordance to a non-limiting embodiment. Disabler circuitry 23 is configured to track the current date and time and compare them to a database of Sabbath commencement and exit times corresponding to respective, geographical zones stored in memory device 24. Furthermore, disabler circuit 23 is linked to switch 2 and bypass circuit 21A to provide typical electrical functionality when the door switch 2 is disabled, according to certain embodiments.

In certain embodiments, normal device functionality is regulated by a timer-driven regulator 21C when switch 2 is disabled, according to embodiments.

System 23A may be configurable to provide users with the option of defining a lead time at which system 23A disables switch 2 prior to Sabbath commencement, typically on Friday afternoon, and a particular geographical zone. It should be appreciated that system 23A may be implemented electronically, digitally, mechanically, or a combination of such means.

FIG. 8C is a flowchart depicting the operational steps of the system of FIG. 8. In step 30 the current date, time and geographical location are tracked and in step 31 these parameters are compared with the designated date, time and geographical parameters identified for by the user. If the current time is less than the designated cut-off time, processing continues at step 30. However, if the current time is equal to or exceeds the designated cut-off time, processing continues to step 32 where the switch is rendered non-responsive. In step 33, the system continues tracking the current time and in step 34 compares it with the Sabbath-departure or exit time of Saturday night. If the current time is

earlier than the designated Sabbath departure time, the system continues checking the current time with the stored, Sabbath departure time, every five or ten minutes, in non-limiting embodiments. When the current time achieves the post Sabbath departure time, the system restores normal switch functionality in step 35, according to embodiments.

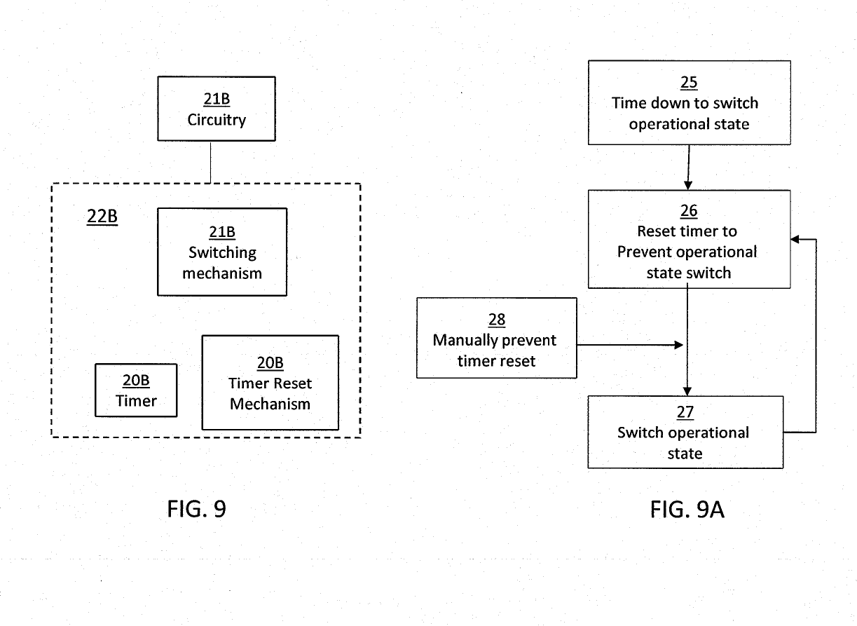

Referring to FIGS. 9 and 9A relate to a non-limiting embodiment of an electric switch disabler system 22B directed at allowing electrical circuitry to change operational states in a manner compliant with Jewish law by actuating a switch biased to periodically change its electrical state by disabling a governor countering the switch biasing, according to an embodiment.

FIG. 9 depicts a time-switch 2A actuated by a passage of a pre-defined switch time, switch governor 24 configured to counter the switch biasing by resetting a switch timer 2B prior to the passage of the pre-defined switching time, and a switch-governor disabler 25 configured to disable the switch governor 24 when actuated either manually or automatically, according to a certain non-limiting embodiment. Certain embodiments may use non-time based parameters as biasing elements.

In operation, in step 26 timer switch 2B associated with time actuated switch 2B times a period of time, or switching time, that upon its passage time-switch 2B is actuated. In step 28 switch timer 2B is reset prior to the passage of the switching time so that when a decision is made in step 28, the switching time has not elapsed and processing returns to step 26 where switch timer 2B begins to time the passage of switching time again. In step 29, a user manually actuates switch-governor disabler 25 so that the switch timer 2B is not reset thus enabling switching time to elapse. After its elapse processing continues from step 30 to step 31 where time switch 2B is actuated and a change in the electrical state is

accomplished in a manner compliant with Jewish law. It should be appreciated that switch-governor disabler may be actuated automatically in certain embodiments. Furthermore, the system 22B may be implemented digitally, electronically, or mechanically or any combination of them. As noted above, this system may be implemented as a retrofit switch in certain embodiments.

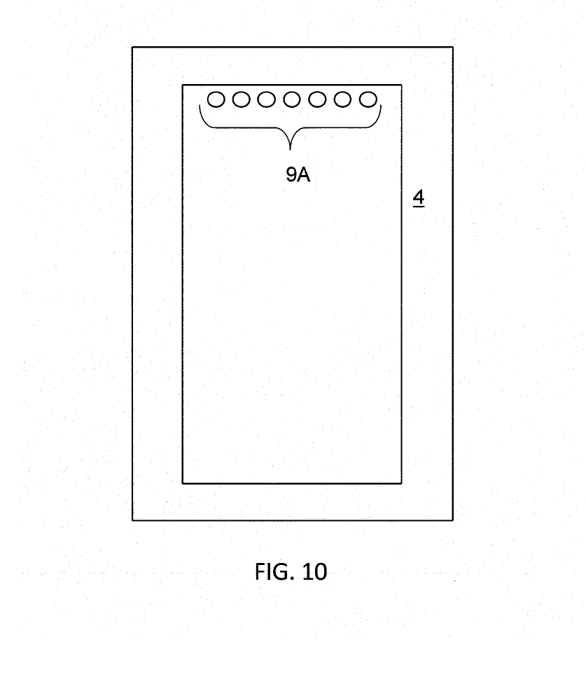

FIG. 10 depicts a refrigerator having an alternative lighting arrangement employing low-power consuming light emitting diodes (LEDs) as a light source. The low power consumption advantageously reduces the need to deactivate a power-consuming incandescent lamps normally used in refrigerators. Such lower powered light sources can be configured to be permanently activated so that they remain lit even while the door is closed.

It will be appreciated that for simplicity and clarity of illustration, elements shown in the figures are not necessarily drawn to scale and reference numerals may be repeated in different figures to indicate corresponding elements.

1. A system for temporarily disabling an electrical switch comprising:
an electrical, push switch configured to change a state of an electrical circuit when a force is applied to the switch by a door of an electrical device;
a lock mechanism configured to render the switch non-responsive to the force applied to the switch by the door while maintaining a current state of the circuit.

2. The system of claim 1, wherein the lock mechanism is implemented non-integrally to the push switch.

3. The system of claim 2, wherein the lock mechanism is rotatably actuated.

4. The system of claim 3, wherein the lock mechanism includes a flexible cord linked to the switch.

5. The system of claim 2, wherein the lock mechanism is implemented as a retrofit lock unit.

6. The system of claim 1, wherein the lock mechanism is implemented integrally to the push switch.

7. The system of claim 6, wherein the switch includes a magnetically responsive element configured to disable the switch responsively to a magnetic field.

8. The system of claim 1, wherein the lock mechanism is actuated by timer.

9. The system of claim 8, wherein the timer is configured to actuate the lock mechanism in accordance with a time based on sunset every Friday.

10. The system of claim 9, wherein the time based on sunset is defined in accordance with geographical location.

11. The system of claim 8, wherein the timer is configured to actuate the lock mechanism responsively to a time period in which the door of the device is in an open state.

12. The system of claim 1, further comprising a timing arrangement configured to time a period of time for which the door of the device is in an open state.

13. A system for temporarily disabling an electrical switch comprising:
an electrical, push switch configured to change an electrical state when a force is applied to the switch by a door of an electrical device; and
a moveable, switch-contact-element disposed in the door such that in a first position switch activation is achieved upon door-closure and in a second position non-activation of the switch is achieved upon door closure.

14. The system of claim 13, wherein the switch-contact-element is implemented as slideable cover covering a cavity disposed in the door.

15. The system of claim 13, wherein the switch-contact-element is implemented as a slideable or rotatable protuberance.

16. A method for disabling a door-actuated, electrical-switch of an electric device comprising:
providing an electrical-push-switch disposed in an electrical circuit of an electrical device,
a lock mechanism operative to disable the switch while maintaining a current state of the circuit; and
causing the lock mechanism to disable the switch while the door is in a closed state.

17. The method of claim 16, wherein the step of rendering the switch unresponsive is implemented in accordance with a database of Sabbath commencement times stored in a memory device.

18. The method of claim 17, wherein the database of Sabbath commencement times are geographically dependent.

19. The method of claim 16, further comprising a step of automatically enabling the switch in accordance with Sabbath exit times, the Sabbath exit times stored in a memory device.

20. The method of claim 19, wherein the Sabbath exit times are geographically dependent.
